(19) United States
(12) Patent Application Publication
(10) Pub. No.: US 2026/0148880 A1
(43) Pub. Date: May 28, 2026

(54) TECHNIQUES FOR FORMING A CONDUCTIVE JOINT BETWEEN SUPERCONDUCTING CABLES AND RELATED SYSTEMS AND METHODS

(71) Applicant: Commonwealth Fusion Systems LLC, Devens, MA (US)

(72) Inventor: Ruben Rui Diaz-Pacheco, Boston, MA (US)

(73) Assignee: Commonwealth Fusion Systems LLC, Devens, MA (US)

(21) Appl. No.: 19/307,632

(22) Filed: Aug. 22, 2025

Related U.S. Application Data
(60) Provisional application No. 63/686,644, filed on Aug. 23, 2024.

(51) Int. Cl. H01B 12/02; H01B 12/14; H01B 12/16; H01F 6/06; H02G 15/113

(52) U.S. Cl. CPC H01B 12/02; H01B 12/14; H01B 12/16; H01F 6/06; H02G 15/113

(57) ABSTRACT

Techniques are provided for fabricating an improved joint between superconducting cables by attaching a joint box to the end of a superconducting cable prior to filling the cable with solder. The core at one end of a cable is arranged within a joint box, and one or more conductive joint elements are arranged over the end of the cable and within the joint box prior to solder-filling. Subsequent to solder-filling, the core at one end of the cable is embedded within the joint box and electrically connected to the one or more conductive joint elements. The one or more conductive joint elements can then be modified to be planar. By repeating this process for another superconducting cable, the planar surface of each cable can be arranged face-to-face and electrically connected to one another, thereby producing a conductive joint between the cables.

### BACKGROUND

Superconductors are materials that have no electrical resistance to current (are “superconducting”) below some critical temperature. For many superconductors, the critical temperature is below 30°K, such that operation of these materials in a superconducting state requires significant cooling, such as with liquid helium.

High-field magnets are often constructed from superconductors due to the capability of superconductors to carry a high current without resistance. Such magnets may, for instance, carry currents greater than 5 kA.

### SUMMARY

According to some embodiments, there is provided a superconducting cable comprising: a core comprising a plurality of high temperature superconductor (HTS) components; a joint box arranged at an end of the superconducting cable, with a portion of the core arranged inside the joint box; a plurality of conductive joint elements arranged at least partially within the joint box and arranged side-by-side over the portion of the core arranged inside the joint box; one or more insulating layers arranged between adjacent ones of the plurality of conductive joint elements; and solder arranged within the core and within the joint box.

In some embodiments, the superconducting cable further comprises a jacket surrounding portions of the core outside of the joint box.

In some embodiments, an end of the jacket is attached to the joint box.

In some embodiments, the solder contacts the plurality of HTS components and the plurality of conductive joint elements.

In some embodiments, the core comprises a plurality of conductive segments extending along the cable, each of the plurality of conductive segments comprising one or more of the plurality of HTS components.

In some embodiments, the superconducting cable further comprises an insulating material arranged between adjacent conductive segments of the plurality of conductive segments in the core, which electrically insulate the plurality of conductive segments from one another.

In some embodiments, the core further comprises at least one interior cooling channel.

In some embodiments, the plurality of HTS components comprise a plurality of HTS tapes, and wherein a stack of HTS tapes is arranged within each conductive segment of the plurality of conductive segments.

In some embodiments, the plurality of conductive segments are twisted around a central axis of the superconducting cable, and wherein the one or more HTS components in each conductive segment follow a helical path around the central axis.

In some embodiments, the joint box further comprises an outlet, and wherein the solder is arranged up to or beyond the outlet.

In some embodiments, a first conductive joint element of the plurality of conductive joint elements is arranged adjacent to one or more HTS components arranged within a first conductive segment of the plurality of conductive segments of the core, and wherein a second conductive joint element of the plurality of conductive joint elements is arranged adjacent to one or more HTS components arranged within a second conductive segment of the plurality of conductive segments of the core.

In some embodiments, the super conducting cable further comprises insulating material on a portion of a lower surface of the first conductive joint element such that a remaining portion of the lower surface is adjacent to and follows a shape of the helical path of the one or more HTS components arranged within the first conductive segment.

In some embodiments, the joint box comprises a plurality of through holes.

In some embodiments, the plurality of conductive joint elements collectively exhibit a planar upper surface.

In some embodiments, the plurality of conductive joint elements each has a concave portion in its lower surface.

According to some embodiments, there is provided a superconducting magnet comprising: a first superconducting cable comprising: a first core comprising a first plurality of high temperature superconductor (HTS) components; a first joint box arranged at an end of the first superconducting cable, with a portion of the first core arranged inside the first joint box; a first plurality of conductive joint elements arranged at least partially within the first joint box and arranged side-by-side over the portion of the first core arranged inside the first joint box, wherein the first plurality of conductive joint elements collectively exhibit a first planar surface; a second superconducting cable comprising: a second core comprising a second plurality of high temperature superconductor (HTS) components; a second joint box arranged at an end of the second superconducting cable, with a portion of the second core arranged inside the second joint box; a second plurality of conductive joint elements arranged at least partially within the second joint box and arranged side-by-side over the portion of the second core arranged inside the second joint box, wherein the second plurality of conductive joint elements collectively exhibit a second planar surface; and solder arranged within; the first core, the second core, the first joint box and the second joint box, wherein the first planar surface and the second planar surface are arranged face-to-face with one another and electrically connected to one another.

In some embodiments, the superconducting magnet further comprises a first jacket surrounding portions of the first core outside of the first joint box, and a second jacket surrounding portions of the second core outside of the second joint box.

In some embodiments, an end of the first jacket is attached to the first joint box, and wherein an end of the second jacket is attached to the second joint box.

In some embodiments, the superconducting magnet further comprises a layer of indium arranged between the first planar surface and the second planar surface.

In some embodiments, the superconducting magnet further comprises a plurality of fasteners that attach the first joint box to the second joint box.

In some embodiments, the first joint box comprises a first plurality of through holes and wherein the second joint box comprises a second plurality of through holes, and wherein each of the plurality of fasteners passes through one of the first plurality of through holes and one of the second plurality of through holes.

In some embodiments, the solder comprises: a first region of solder within the first core and the first joint box, the first region of solder being in contact with the first plurality of HTS components and the first plurality of conductive joint elements; and a second region of solder, separate from the first region of solder, within the second core and the second joint box, the second region of solder being in contact with the second plurality of HTS components and the second plurality of conductive joint elements.

In some embodiments, the first joint box further comprises an outlet, and wherein the first region of solder is arranged up to or beyond the outlet.

In some embodiments, the first core comprises a plurality of conductive segments extending along the cable, each of the plurality of conductive segments comprising one or more of the first plurality of HTS components.

In some embodiments, the superconducting magnet further comprises an insulating material arranged between adjacent conductive segments of the plurality of conductive segments in the first core, which electrically insulate the plurality of conductive segments from one another.

In some embodiments, the plurality of conductive segments are twisted around a central axis of the first superconducting cable, and wherein the one or more HTS components in each conductive segment follow a helical path around the central axis.

In some embodiments, a first conductive joint element of the plurality of conductive joint elements is arranged adjacent to one or more HTS components arranged within a first conductive segment of the plurality of conductive segments of the first core, and wherein a second conductive joint element of the plurality of conductive joint elements is arranged adjacent to one or more HTS components arranged within a second conductive segment of the plurality of conductive segments of the first core.

In some embodiments, the superconducting magnet further comprises insulating material on a portion of a lower surface of the first conductive joint element such that a remaining portion of the lower surface is adjacent to and follows a shape of the helical path of the one or more HTS components arranged within the first conductive segment.

In some embodiments, the first plurality of conductive joint elements each has a concave portion in its lower surface.

A method of forming a joint between superconducting cables, the method comprising: inserting an end of a superconducting cable core comprising a plurality of high temperature superconductor (HTS) components into a joint box; arranging one or more conductive joint elements over portions of the superconducting cable core within the joint box; directing a molten metal through the superconducting cable core and through the joint box, thereby electrically connecting at least some of the plurality of HTS components to at least some of the one or more conductive joint elements via the molten metal; and subsequent to cooling of the molten metal, removing material from an exposed upper surface of the one or more conductive joint elements to form a planar surface.

In some embodiments, the method further comprises providing a jacket around the superconducting cable core after inserting the end of the superconducting cable core into the joint box and prior to directing the molten metal through the superconducting cable core and through the joint box, wherein the jacket is arranged around portions of the superconducting cable core outside of the joint box.

In some embodiments, the method further comprises welding an end of the jacket to the joint box.

In some embodiments, the method further comprises attaching a lid over the joint box, enclosing the end of the superconducting cable core and the one or more conductive joint elements within the joint box, prior to directing the molten metal through the superconducting cable core.

In some embodiments, the superconducting cable core is a first superconducting cable core, wherein the planar surface is a first planar surface, and wherein the method further comprises: repeating said acts of inserting, arranging, directing, and removing for a second superconducting cable core to form a second planar surface; and arranging the first planar surface face-to-face with the second planar surface, thereby electrically connecting the first superconducting cable core to the second superconducting cable core.

In some embodiments, the method further comprises fastening the joint box comprising the first superconducting cable core to a joint box comprising the second superconducting cable core subsequent to arranging the first planar surface face-to-face with the second planar surface.

In some embodiments, the method further comprises arranging a layer of indium between the first planar surface and second planar surface prior to arranging the first planar surface face-to-face with the second planar surface.

In some embodiments, fastening the joint box comprising the first superconducting cable core to the joint box comprising the second superconducting cable core, subsequent to arranging the first planar surface face-to-face with the second planar surface, comprises passing a first plurality of fasteners through a plurality of holes in the joint box comprising the first superconducting cable core and through a plurality of holes in the joint box comprising the second superconducting cable core, and wherein the method further comprises, prior to directing the molten metal through the superconducting cable core, attaching a lid over the joint box comprising the first superconducting cable core, thereby enclosing the end of the first superconducting cable core and the one or more conductive joint elements within the joint box, wherein the lid is fastened to the joint box comprising the first superconducting cable core at least in part by passing a second plurality of fasteners through the plurality of holes in the joint box comprising the first superconducting cable core.

In some embodiments, the one or more conductive joint elements each has a concave portion in its lower surface.

In some embodiments, the method further comprises arranging the one or more conductive joint elements alongside one another with a layer of insulating material arranged between adjacent conductive joint elements.

In some embodiments, the method further comprises attaching an end cap to the joint box, and wherein the molten metal flows through the end cap during said act of directing the molten metal through the superconducting cable core and through the joint box.

In some embodiments, the superconducting cable core comprises: the plurality of HTS components; and a plurality of conductive segments extending along the superconducting cable core, each of the plurality of conductive segments comprising one or more of the plurality of HTS components.

In some embodiments, the method further comprises arranging a first conductive joint element of the one or more conductive joint elements adjacent to one or more HTS components arranged within a first conductive segment of the plurality of conductive segments, and arranging a second conductive joint element of the one or more conductive joint elements adjacent to one or more HTS components arranged within a second conductive segment of the plurality of conductive segments.

In some embodiments, the plurality of conductive segments are twisted around a central axis of the superconducting cable core, and wherein the one or more HTS components in each conductive segment follow a helical path around the central axis.

In some embodiments, the method further comprises arranging insulating material on a portion of a lower surface of the first conductive joint element such that a remaining portion of the lower surface is adjacent to and follows a shape of the helical path of the one or more HTS components arranged within the first conductive segment.

In some embodiments, the plurality of HTS components comprise a plurality of HTS tapes.

In some embodiments, the superconducting cable core further comprises an insulating material arranged between adjacent conductive segments of the plurality of conductive segments that electrically insulates the plurality of conductive segments from one another.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a perspective view of a superconducting cable, according to some embodiments;

FIGS. 2A-2C depict an illustrative example of a conductive structure representing one side of a joint between superconducting cables, according to some embodiments;

FIG. 3A is a cross-sectional view of a joint box, according to some embodiments;

FIG. 3B is a perspective view of the joint box of FIG. 3A, according to some embodiments;

FIG. 3C depicts a perspective view of a conductive joint element as used in the example of FIGS. 2A-2C, according to some embodiments;

FIG. 4A is a cross-sectional view of an illustrative example of an HTS cable comprising a core that includes a former and HTS material, according to some embodiments;

FIG. 4B is a cross-sectional view of an illustrative embodiment of the superconducting cable shown in FIGS. 2A-2C in which the core includes a former and HTS material, according to some embodiments;

FIG. 4C depicts an isometric view of a superconducting cable having portions of an outer jacket removed to reveal multiple conductive segments in a twisted configuration, according to some embodiments;

FIGS. 5A-5H depict steps in a process of forming an illustrative superconducting cable joint, according to some embodiments;

FIG. 6 depicts a cross-sectional view of the joint between two superconducting cables produced by the process depicted in FIGS. 5A-5H, according to some embodiments;

FIG. 7 depicts two instances of a superconducting cable coupled together to form a joint, according to some embodiments;

FIG. 8 is a flowchart of a method of forming a joint between superconducting cables, according to some embodiments;

FIGS. 9A-9B are a flow diagram of a method of metal-filling a superconducting cable, according to some embodiments;

FIG. 10 is a three-dimensional graphic of a fusion machine with a cutaway portion illustrating various components of a tokamak, according to some embodiments; and

FIG. 11 depicts a cross-sectional view of the layers of an illustrative coated-conductor HTS tape, according to some embodiments.

### DETAILED DESCRIPTION

Some high-field superconducting magnets comprise multiple turns of an electrically insulated cable. When superconducting material within the cable is cold enough to be below its critical temperature (the temperature below which the electrical resistivity of the material drops to zero), driving the magnet allows current to pass through the superconducting material without losses. Some such cables comprise a high temperature superconductor (HTS) material, which is a type of superconductor with a higher critical temperature (e.g., above 30K).

For various reasons, during operation some or all of the superconducting material in a superconducting magnet may be heated to above its critical temperature and therefore lose its superconducting characteristics. If uncontrolled, such heating can lead to the superconductor losing its superconducting abilities in a process referred to as a “quench.” If a quench is not properly addressed by the system (e.g., by shutting down current flow into the magnet), components can be damaged by the heating.

Some superconducting magnet systems handle quench events via a system of active alarms and detection mechanisms. Other superconducting magnet systems handle quenches passively through design of the superconducting magnet itself. An example of the latter approach is a non-insulated (NI) magnet, in which some superconducting portions of the magnet are not insulated from one another but are instead separated by a conventional conductor (i.e., not a superconductor). When the magnet is operating below the superconductor's critical temperature, current flows through the superconductor and not through the conventional conductor because the superconductor has zero resistance compared with the finite resistance of the conductor that lies between the turns. During a quench, current can flow through both the conventional conductor and the superconductor, limiting possible damage to the superconducting material that might be caused by the high current.

Superconducting cables comprising HTS material (“HTS cables”) may in some cases be implemented in a non-insulated approach, in which an HTS cable is placed in an electrically conductive supporting structure to produce a non-insulated magnet. HTS cables may also in some cases be implemented in an insulated approach, in which an HTS cable comprises a core that includes HTS material, and an insulating structure (e.g., a jacket) is arranged around the core. In either case, some HTS cables comprise HTS material arranged within an electrically conducting structure, such as an electrically conducting structure that supports the HTS material. The electrically conducting structure, sometimes referred to as a “former,” may include multiple channels into which the HTS material is arranged.

Some prior HTS cables have employed a so-called Vacuum Pressure Impregnation (VPI) process in which the HTS cable is heated and a molten solder is passed into and through open channels in the cable. The solder may flow into open spaces in the cable structure, filling them with an electrically conductive material. For instance, in an insulated HTS cable comprising a former and HTS material, solder may flow within a jacket, filling space between the HTS material, the former and the jacket.

For some applications, it can be desirable to electrically connect together multiple HTS cables. For instance, a magnet for a tokamak (e.g., a poloidal field magnet) may be formed from a number of superconducting cables that are electrically connected to one another (e.g., by indium pressed connection(s)). Conventionally, to electrically connect multiple superconducting cables, the cables are first fully formed, which typically includes forming the jacket around the core of the cable to contain the core components (e.g., a former and HTS material arranged within it), and solder-filling the cable to fix the core components in place as described above. To connect the cable in a joint, part of the jacket around the end of the cable must then be removed to expose the conductive core of the cable (e.g., a combination of the former, HTS material and solder). The exposed ends of a cable may then be plated and electrically coupled to another such cable in a structure often called a ‘joint.’ A joint may for instance comprise a conductive structure comprising two half-saddle structures into which an exposed and plated end of each cable may be arranged, so that the joint electrically connects the two cables.

This conventional process to form a joint between superconducting cables presents challenges, however. Removing the material from a cable in preparation for forming the joint can lead to damage of the cable due to the level of precision required to remove the jacket without damaging the core of the cable. The solder-filling process introduces solder at least partially around the former, and this material needs to be removed (e.g., sanded away, to facilitate better contact with the core of the cable and reduce resistance) before forming the joint, which can produce hazardous material. Ideally, this manual process to remove the outer parts of the end of the cable results in a perfectly cylindrical cable end, though in practice that is difficult to achieve. Moreover, it may not be precisely known what the dimensions of the cable end will be after this removal process, and so a saddle structure (e.g., a half-saddle or a full saddle) that fits the cable may need to be custom-machined to match. Finally, when arranging the cable end within the half-saddle of the joint, a soft conductive metal such as indium is typically added into the half-saddle so that the cable can be pressed into the half-saddle to form a consistent and reliable electric connection to the joint. Applying such a material onto a curved surface and making it a consistently-thick layer is challenging, however, and this press-fitting can sometimes lead to gaps between the cable and the joint. As a consequence of the above-described challenges, joints in superconducting cables can be difficult to form reliably, and issues can arise while forming the joint that could irreversibly damage the cable.

The inventor has recognized and appreciated techniques for fabricating an improved joint between superconducting cables by attaching a joint box to the end of a superconducting cable prior to filling the cable with solder. In particular, the core at one end of the cable is arranged within the joint box, and one or more conductive joint elements are arranged over the end of the cable and within the joint box prior to solder-filling. A jacket may be arranged around parts of the core outside of the joint box. The joint box includes one or more outlets so that, during solder-filling, solder can flow through the cable and joint box, then pass through the outlet(s). Subsequent to solder-filling, the core at one end of the cable is embedded within the joint box and electrically connected to the one or more conductive joint elements, whereas a remainder of the cable includes a solder-filled core within a jacket. The one or more conductive joint elements can then be modified to be planar (e.g., machined flat), thereby producing a conductive structure at the end of a cable with a flat surface. By repeating this process for another superconducting cable, the planar surface of each cable can be arranged face-to-face and electrically connected to one another, thereby producing a conductive joint between the cables.

As a result of these techniques, a joint for a superconducting cable may be produced in a way that is more reliable and with reduced risk of damage to the cable.

According to some embodiments, a superconducting cable may be formed without a jacket at its end, where the end is then arranged within a joint box as described above. Since the jacket is added prior to solder-filling a superconducting cable, conventionally the jacket is added then cut away after solder-filling to expose the end of the cable for a joint. With the techniques described herein, however, the jacket need not be initially provided at the end of the cable. For instance, the end of the core of the cable may be inserted into the joint box up to its jacket, then the end enclosed in the joint box. Alternatively, a jacket may be added around part of the core after inserting the end of the core into the joint box. In either case, subsequent solder-filling of the cable may deposit solder into the cable and into the joint box, fixing the cable's core components (e.g., former, HTS material) into place, as well as fixing the end of the cable in the joint box. As a result, a joint may be formed without it being necessary to remove any portion of the jacket of a superconducting cable.

According to some embodiments, the one or more conductive joint elements may be shaped with a concave lower surface (or with at least part of the lower surface being concave), wherein the lower surface sits on, or just above, the end of the superconducting cable's core. Such a shape may provide a desirably large conductive surface area close to the cable. For instance, the lower surface may have a cross-sectional shape of a half-circle. In some cases, a lower surface of a conductive joint element may be partially covered with an insulating material. In cases where a superconducting cable includes discrete regions of superconducting material, it may be desirable to arrange a lower surface of a conductive joint element so that surfaces of the conductive joint element are arranged proximate to a region of superconducting material, with insulated surfaces of the conductive joint element being arranged on a remainder of the lower surface. This arrangement may lead to a more direct, and thereby less resistive, current flow through a conductive joint element and into the superconducting material in the cable.

According to some embodiments, the one or more conductive joint elements may, when arranged within the joint box, have a flat or substantially flat upper surface. The upper surface(s) of the one or more conductive joint elements are later machined to be planar, so there may be a benefit in initially using conductive joint elements that have flat or close to flat upper surfaces. However, since the upper surface may be subsequently modified to be planar, the upper surfaces may have any suitable initial shape, and are not limited to being initially flat. According to some embodiments, any suitable subtractive technique or techniques may be employed to form a planar upper surface among the one or more conductive joint elements. Suitable techniques may include, but are not limited to, milling, grinding, sanding, machining, polishing, or combinations thereof.

According to some embodiments, a joint box may be configured to couple to another joint box when they are electrically connected to form a joint between two superconducting cables. In some cases, a joint box may include one or more features that allow it to attach to another joint box, such as one or more through holes, clamps, clasps, mating components, latches, or combinations thereof. In some cases, such features may be utilized with other components to form said attachment. For instance, fasteners such as bolts may be arranged within through holes in both joint boxes that align with one another so that the joint boxes can be fastened together. In some embodiments, features in a joint box that allow it to connect to another joint box may also be configured to be used to connect to a lid or other enclosing element fastened to the joint box prior to solder-filling the cable. For instance, fasteners such as bolts may be provided through holes in a joint box such as those mentioned above both when attaching a lid to the joint box for solder-filling and for attaching the joint box to another joint box to form a joint between two superconducting cables (although the same fasteners may not necessarily be used in both cases).

Following below are more detailed descriptions of various concepts related to, and embodiments of, techniques for fabricating an improved joint between superconducting cables. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

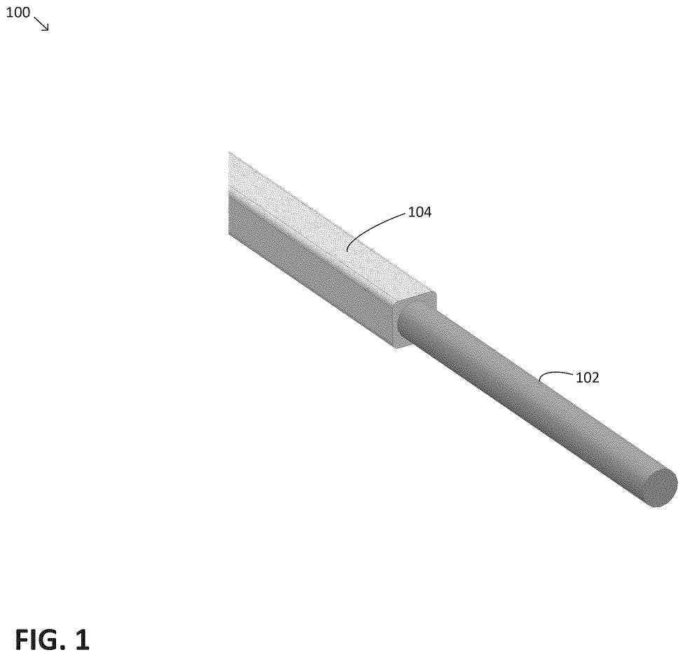

FIG. 1 is a perspective view of a superconducting cable, according to some embodiments. In the example of FIG. 1, superconducting cable 100 includes a core 102 and a jacket 104, and the cable is shown with the core exposed at one end of the cable to more easily illustrate the structure of the cable. While more detailed implementations of core 102 and jacket 104 are described below and shown in the drawings, in general, core 102 comprises one or more HTS components, an HTS component being any suitable component that comprises HTS material. The core 102 may also include one or more conventional conductor (i.e., a non-superconductor) elements, such as, but not limited to, a former or other conducting structure that holds or otherwise supports the one or more HTS components in the core.

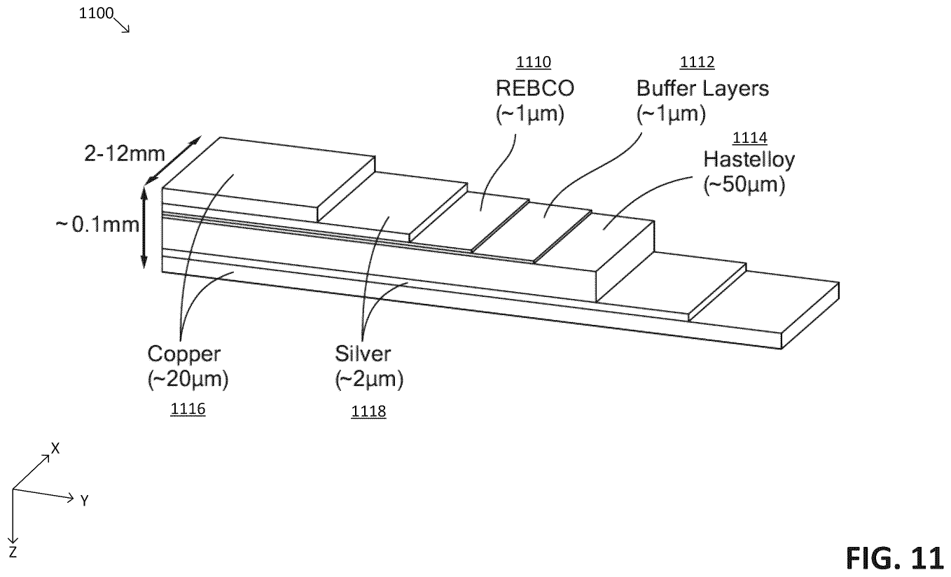

In some cases, the core 102 may comprise HTS tape, which is a long, flat element that comprises a layer of polycrystalline HTS in addition to other layers. In some embodiments, HTS tape may refer to any structure that includes a layer of an HTS, such as a rare-earth cuprate HTS (e.g., REBCO), and which may also contain one or more other layers such as one or more buffer layers, stabilizing layers, substrates, overlay layers and/or cladding layers, such as tape 1100 shown in FIG. 11.

For purposes of illustration, FIG. 11 depicts a cross-sectional view of the layers of an illustrative coated-conductor HTS tape, according to some embodiments. The below description may, in some embodiments, apply to the HTS tapes described herein as being arranged within a magnet or magnet assembly. FIG. 11 is an example of an HTS tape 1100 that is fabricated as a coated conductor, wherein the HTS layer 1110 is a layer of REBCO, which is an acronym for “rare-earth barium copper oxide.” As used herein, in at least some cases “REBCO” may be used to refer more generally to any rare-earth cuprate HTS. As such, unless expressly stated otherwise, barium may be present in REBCO, but is not required to be present. Nonetheless, in the example of FIG. 11 the REBCO layer is provided as one example of an HTS layer and is not intended to limit the illustrated structure to the use of any particular HTS.

In the example of FIG. 11, the illustrative tape 1100 also includes a buffer layer 1112, a Hastelloy@ layer 1114, and copper and silver layers 1116 and 1118, respectively, which are arranged both above and below the REBCO layer. The copper layer is sometimes referred to as a “stabilizer” layer. Illustrative dimensions of the tape are shown in FIG. 11, with the tape having a width (size in the X direction) of around 2-12 mm and a thickness (size in the Z direction) of around 0.1 mm.

According to some embodiments, the core 102 may comprise one or more stacks of HTS tape, which may comprise a large number of HTS tapes arranged on top of one another in the Z direction. Stacks of HTS tape may also comprise tapes formed from a conventional conductor, such as copper tapes, which have similar dimensions to the HTS tape and which are included in the stack of HTS tapes as co-conductors.

According to some embodiments, the jacket 104 may comprise, or may consist of, steel, steel, Inconel®, Nitronic® 40, Nitronic® 50, Incoloy®, or combinations thereof. According to some embodiments, the jacket 104 may comprise, or may consist of, a dielectric layer (e.g., a layer of polyimide such as Kapton®, a fiberglass cloth). A dielectric material, or a layer of dielectric material, may also be referred to herein as an “insulating material,” or a “layer of insulating material.” In some embodiments, the jacket 104 may comprise multiple layers of the aforementioned materials, in any suitable order (e.g., a jacket may comprise a layer of polyimide, which is surrounded by a layer of fiberglass).

The above description of a core and jacket of a superconducting cable also apply to any core or jacket elements described in relation to the embodiments below.

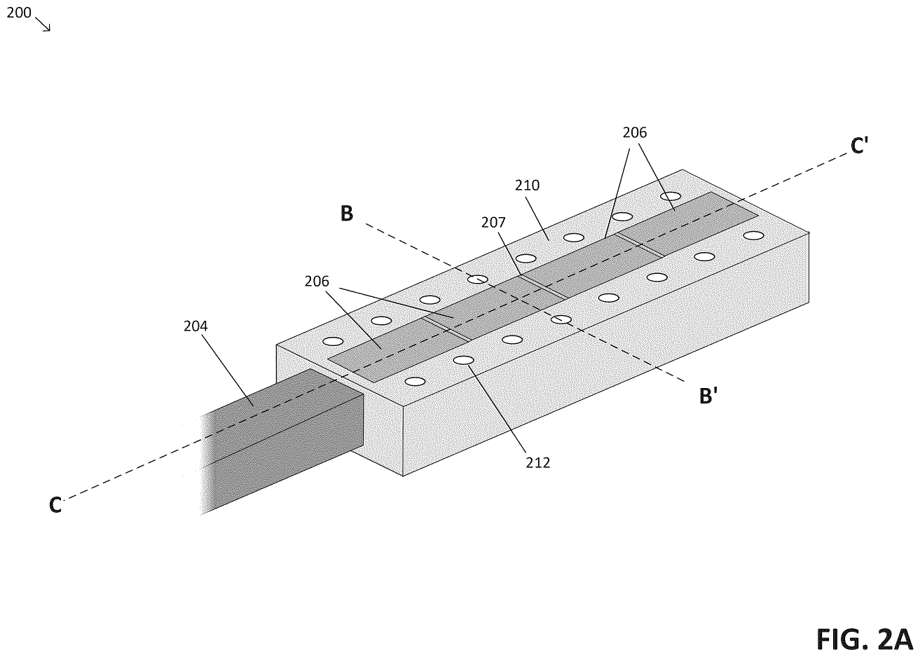

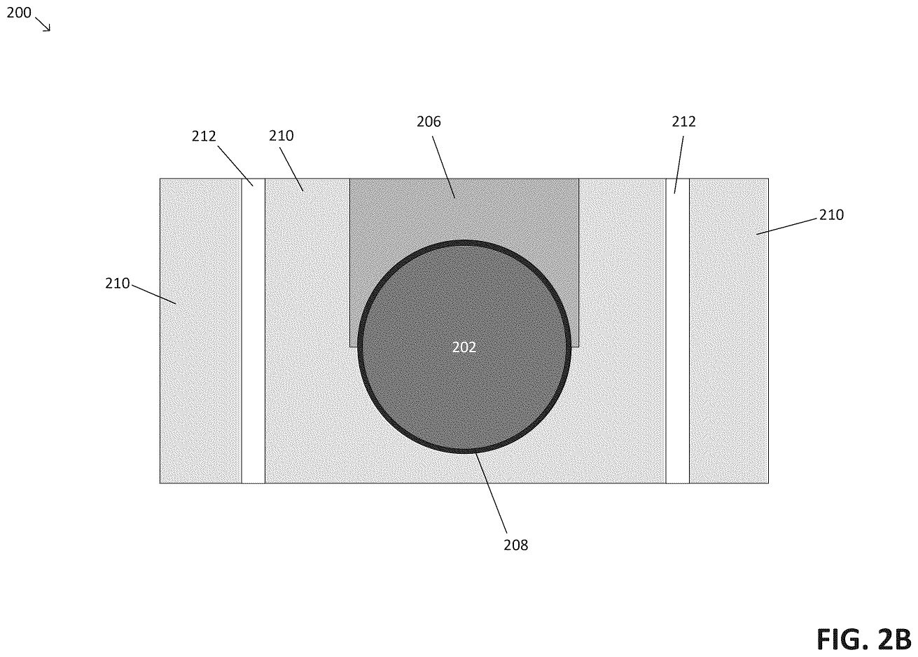

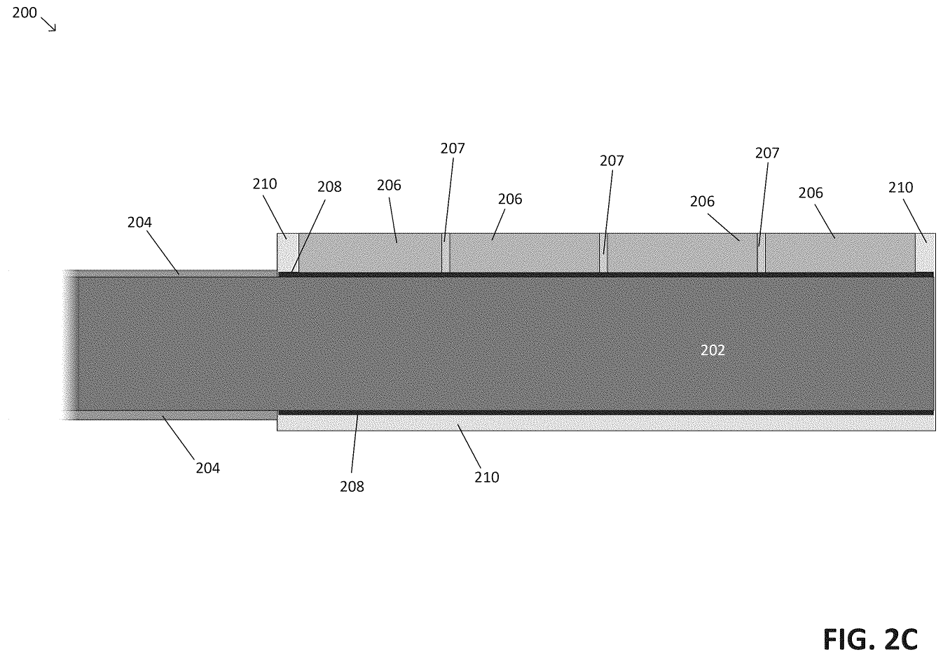

As described above, a conductive structure representing one side of a joint may be formed in part by inserting the end of a core of a superconducting cable into a joint box, arranging one or more conductive joint elements over the core inside the joint box, and then solder-filling the cable and joint box. FIGS. 2A-2C depict an example of a conductive structure formed by such a process, according to some embodiments. In the example of FIGS. 2A-2C, FIG. 2A is a perspective view of the end of an illustrative superconducting cable formed via the techniques described herein, FIG. 2B is a cross-sectional view of the same cable through axis B-B′, and FIG. 2C is a cross-sectional view of the cable through axis C-C′.

In the example of FIGS. 2A-2C, a core 202 is arranged within the joint box 210 with portions of the core outside the joint box surrounded by a jacket 204. Conductive joint elements 206 are arranged side-by-side over the portion of the core within the joint box, and as shown have an upper surface that is planar with the top of the joint box 210. Accordingly, two such joint boxes may be arranged face-to-face to form a joint, as described above. In the example of FIGS. 2A-2C, through holes 212 are provided to couple two joint boxes together in such an arrangement. For instance, the through holes in each of the two joint boxes may be aligned and bolts inserted through the holes in both joint boxes and attached with nuts to form a mechanically robust and electrically conductive path between the conductive joint elements 206 of each joint box.

In the example of FIGS. 2A-2C, solder 208 fills space between the core 202 and the conductive joint elements 206, and between the core 202 and the joint box 210. Techniques for solder-filling a superconducting cable such as that shown in FIGS. 2A-2C are described below. In some embodiments, the solder 208 may comprise, or may consist of, a Pb and/or Sn solder. In some embodiments, the solder 208 may comprise a metal having a melting point of less than 200° C., wherein at least 50 wt % of the metal is Pb and/or Sn. Although not shown in FIGS. 2A-2C, the solder 208 may be arranged within the core 202 in addition to those regions shown in the joint box 210. The solder may for example be supplied as a molten metal into the cable at one end and pushed through the cable to fill space within the core 202 and the joint box 210, and to flow out of the other end of the core or other end of the joint box. The joint box 210 may include an outlet (e.g., adjacent to the end of the core within the joint box) through which solder can flow during such a process.

It will be appreciated that the amount of solder that is arranged between the core and the joint box, or between the core and a conductive joint element, may be small and that the amount shown in FIGS. 2B and 2C may have a much larger relative scale than the amount that in practice is arranged in those locations. However, the solder 208 is depicted with a larger scale in the drawings for purposes of illustration and explanation.

In the example of FIGS. 2A-2C, insulating material 207 is arranged between adjacent ones of the conductive joint elements 206. Insulating material 207 may for instance comprise polyimide. The insulating material 207 is provided so that the conductive joint elements 206 will represent different current paths to the core 202, which as described below may have advantages if the core 202 includes separate regions of superconducting material. For instance, the different conductive joint elements may be arranged so that they each electrically connect to a distinct region of superconducting material in the core.

According to some embodiments, conductive joint elements 206 may comprise, or may consist of, a conductive metal such as copper. As shown in the example of FIGS. 2A-2C, the conductive joint elements may have a lower surface that is concave, or that includes a concave portion, to provide a large surface area adjacent to the core 202. In some embodiments, the conductive joint elements may have a lower surface that includes a concave portion that is a cutout with the shape of part of a cylinder (e.g., a cutout the shape of a half cylinder as shown in the example of FIGS. 2A-2C). Such a shape may conform to the shape of the core, which may generally have a circular cross-section. Other conformal shapes may also be envisioned where the core has a different shape. For example, for a core with a square or rectangular cross-section, the conductive joint elements 206 may have a lower surface shaped with a square- or rectangular-shaped cutout to conformally match the shape of the core.

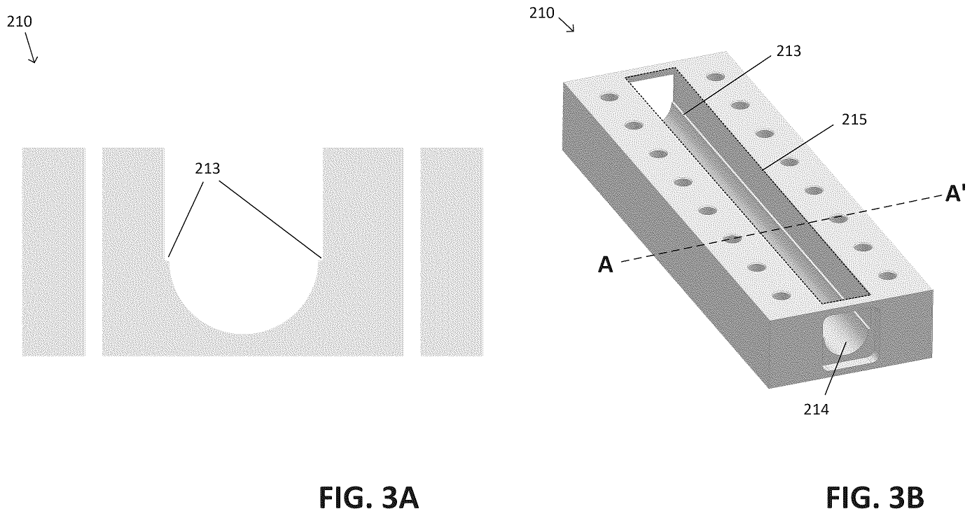

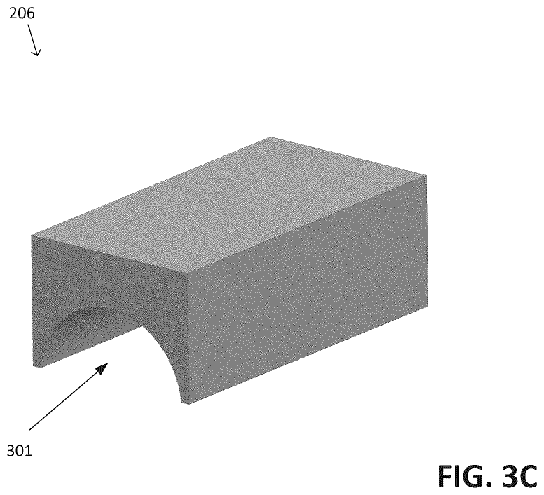

FIG. 3C depicts a perspective view of a conductive joint element 206 as used in the example of FIGS. 2A-2C, according to some embodiments. As described above, the concave portion 301 within the lower surface of the conductive joint element 206 may be a cutout with the shape of a half-cylinder, as shown in FIG. 3C.

In some embodiments, the conductive joint elements 206 may be fabricated so that a cutout portion in the conductive joint elements' lower surfaces is the same size and shape as the portion of the core to which they conform, thereby allowing the conductive joint elements to be fit directly onto the core 202 with little or no gap between them. In other embodiments, the conductive joint elements 206 may be fabricated so that a cutout portion in the conductive joint elements' lower surfaces is the same shape but has a slightly bigger size as the portion of the core to which they conform. The latter case is shown in FIGS. 2A-2C, wherein the conductive joint elements are arranged over the core but there is a small gap between the conductive joint element and core that is filled in with solder 208.

According to some embodiments, joint box 210 may comprise, or may consist of, steel, stainless steel, Inconel®, Nitronic® 40, Nitronic® 50, Incoloy®, or combinations thereof. As described above, in the example of FIGS. 2A-2C, the joint box 210 comprises a plurality of through holes 212 that allow fasteners such as bolts to pass through the holes 212 and fasten the joint box to another component such as a lid (e.g., for enclosing the joint box during solder-filling) and/or to another joint box.

According to some embodiments, joint box 210 may comprise a rail on which the conductive joint elements may rest when they are inserted into the joint box. Such a rail may be seen in FIG. 2B in that conductive joint element 206 includes two flat portions on its lower surface, one on either side of the semi-circular cutout portion. The rail structure of joint box 210 is shown more explicitly in the example of FIGS. 3A and 3B. FIG. 3A is a cross-sectional view of joint box 210 through the axis A-A′ shown in FIG. 3B, which is a perspective view of joint box 210.

As shown in the example of FIGS. 3A and 3B, a rail 213 may be formed in the joint box 210. The rail may have an advantage of allowing the conductive joint elements 206 to be easily moved along the rail (e.g., slid along the rail) prior to solder-filling so that each conductive joint element can be aligned with a different superconducting current path in the core.

In the example of FIG. 3B, the joint box 210 includes an opening 215 in its upper surface. As described above, one or more conductive joint elements 206 may be inserted into this opening to be placed over the core 202. After placing the one or more conductive joint elements, the opening 215 may be fully closed, or there may be one or more residual openings, which can be filled with a suitable material such as putty. While the conductive joint elements 206 are shown in the example of FIGS. 2A-2C as filling the entirety of the opening 215 at the top of the joint box 210, in some implementations the conductive joint elements may be positioned at desired locations along the core (e.g., to align each conductive joint element with a different superconducting current path in the core) and the remaining space in the opening at the top of the joint box may be filled with a suitable material. Subsequent to fabricating the superconducting cable, the one or more conductive joint elements 206 may be modified to be planar with the upper surface of the joint box 210 and with the upper surface of the opening 215.

In the example of FIG. 3B, the joint box 210 includes an outlet 214. The same opening may be provided at both ends of the joint box such that the core is inserted into one of the openings at one end of the joint box, and the other opening acts as the outlet 214 during solder-filling. As described above, during solder-filling the solder may flow through the core, and may flow out of the end of the core through the outlet 214 in the joint box. In other cases, described below, an additional structure (e.g., an end cap) may be attached to the outlet 214 to couple the outlet to a device used during solder-filling.

According to some embodiments, superconducting cable 200 may include the joint box structure as shown in FIGS. 2A-2C at both ends of the cable (so that the structure shown in FIGS. 2A-2C is present at both ends), although in other cases the joint box structure may only be provided at one end of the cable.

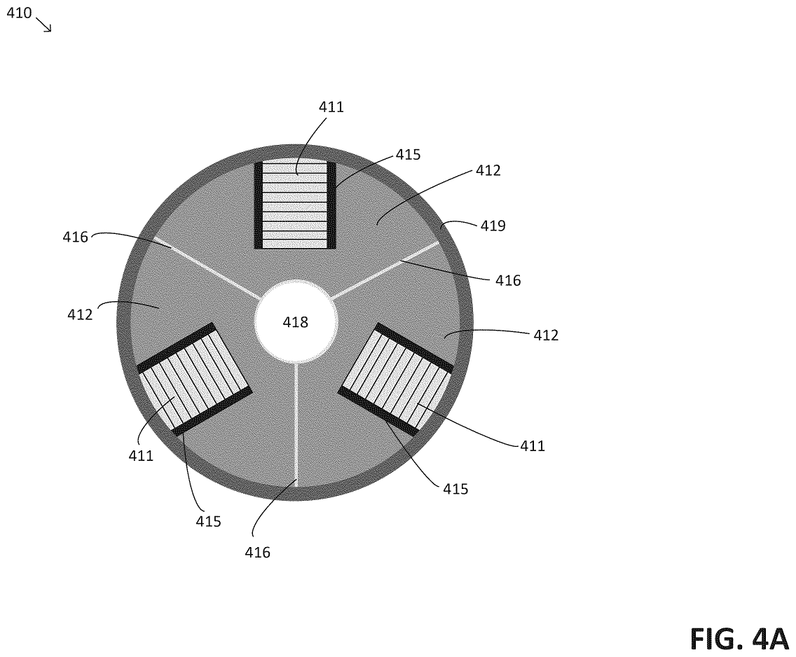

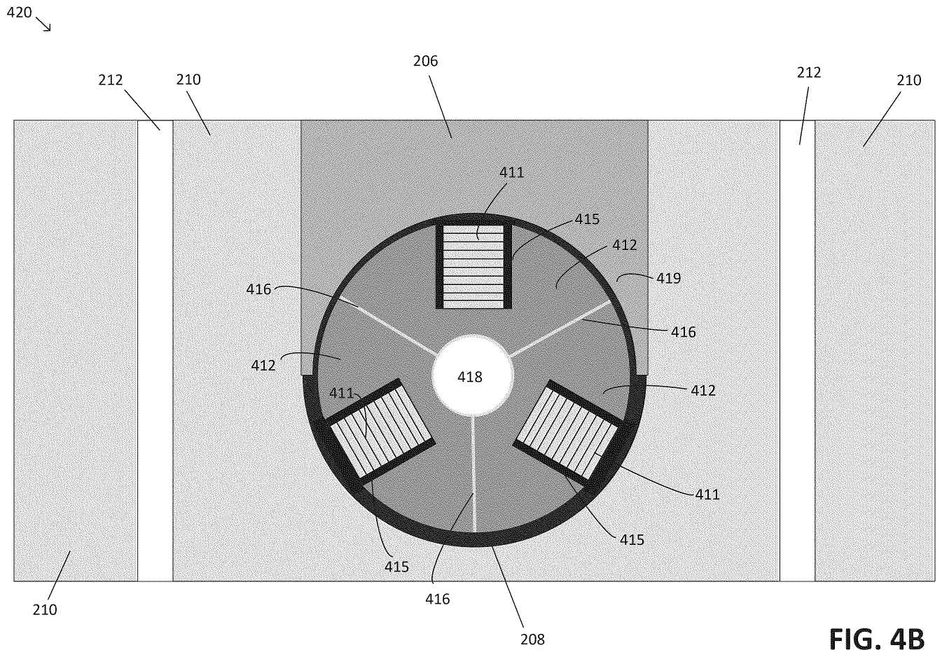

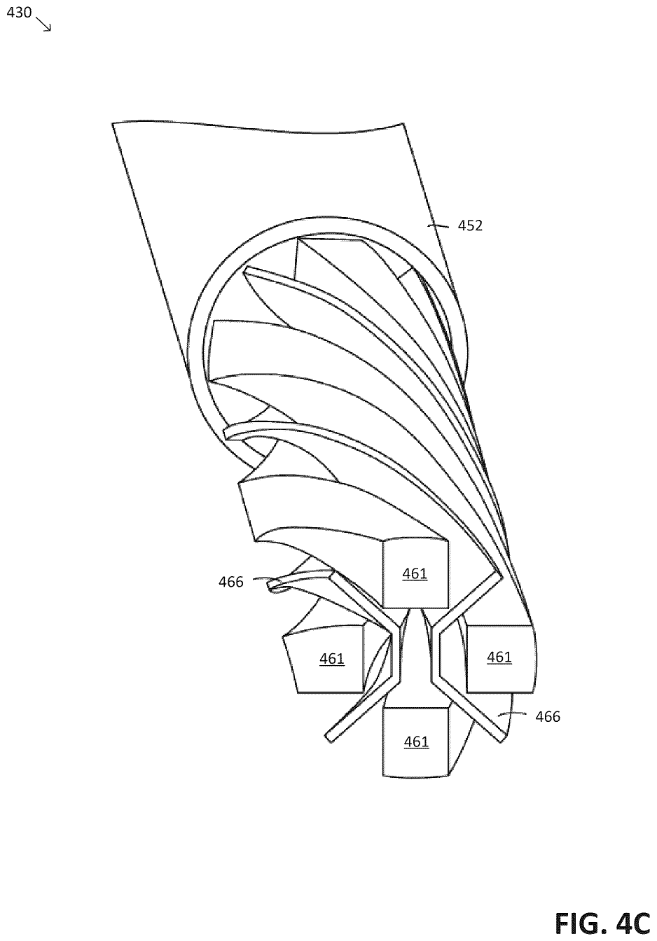

As described above, some HTS cables comprise a core that includes a former and HTS material. FIG. 4A is a cross-sectional view of an illustrative example of such an HTS cable, according to some embodiments.

In the example of FIG. 4A, superconducting cable 410 includes conductive segments 412 arranged in a radially symmetric manner around a central, interior cooling channel 418. The conductive segments 412 are configured to hold respective HTS tape stacks 411 within respective channels within each segment. In the example embodiment of FIG. 4A, the channels are arranged at a perimeter of each segment. It may be noted that cable 410 may be formed from three instances of the same conductive segment 412 arranged as shown in FIG. 4A, The illustrative cable of FIG. 4A comprises a jacket 419 arranged exterior to the conductive segments.

In the example of FIG. 4A, the HTS tape stacks 411 are arranged in contact with solder 415, which provides at least part of the electrical contact between the HTS tape stacks and each respective conductive segment 412. As described above, solder may be provided into a superconducting cable through a solder-filling process, to be described in detail below. The solder 415 may have been supplied into the superconducting cable 410 through such a process, thereby filling space between the HTS tape stacks 411 and the conductive segments 412.

According to some embodiments, conductive segments 412 may comprise, or may consist of, copper. Copper may represent a desirable material due to its high thermal conductivity, thereby providing a stabilizing function in case of a quench, as well as being electrically conductive. Other suitable materials that conductive segments 412 may comprise, or may consist of, include aluminum.

In the example of FIG. 4A, insulating material 416 is arranged to contact different ones of the conductive segments 412 on either side. As shown in FIG. 4A, electrically insulating material 416 is arranged between adjacent pairs of the conductive segments 412, and may be arranged so as to contact both segments of the pair (ideally, so as to leave no gaps, or substantially no gaps, between the electrically insulating material 416 and each conductive segment). In some embodiments, the insulating material 416 may be provided in the form of a tape (e.g., polyimide tape) that may be arranged between the pairs of the conductive segments 412. In some cases, the tape may be an adhesive tape and adhered to the adjacent conductive segments 412 via the adhesive so that the tape is adhered to the conductive segments.

According to some embodiments, insulating material 416 may comprise polyimide (e.g., Kapton®)), epoxy resin, phenolic resin, a plastic, an elastomer, steel (e.g., stainless steel) or combinations thereof. According to some embodiments, insulating material 416 may have a breakdown voltage or dielectric strength of greater than 25 k V/mm, of greater than 50 k V/mm, of greater than 75 k V/mm, of greater than 1000 kV/mm.

According to some embodiments, insulating material 416 may comprise, or may consist of, a high-resistivity material that is nonetheless electrically conductive to some extent. In this respect, references to material 416 being “insulating” refers to the fact that the material 416 is much less electrically conductive than the material making up the conductive segments 412. For instance, in some embodiments, the conductive segments 412 may comprise a highly conductive material such as copper, whereas the insulating material 416 may comprise steel, which is not strictly an insulator but is nonetheless far more insulating than copper.

According to some embodiments, conductive segments 412 may be twisted along the length of the cable 410. That is, the conductive segments 412 may be twisted around a central longitudinal axis of the cable; as such, the cross-sectional view of FIG. 4A may be an accurate view of various points along the cable, but for the rotational orientation of the view shown, which will rotate about the center of the cable as the cross-sectional view is moved along the length of the cable. A helical path is one example of a twisted path that the conductive segments may follow around the central longitudinal axis of the cable. In such a configuration, the conductive segments 412 may be aligned along respective helical paths with a center of each helix being the central longitudinal axis of the cable. Similarly, the HTS tape stacks 411 may be supported by the conductive segments 412 along the length of the cable in the manner shown in FIG. 4A, and thereby also be aligned along respective helical paths with a center of each helix being the central longitudinal axis of the cable.

Arranging the HTS tape stacks 411 along twisted paths may reduce the length over which two conductive paths are parallel to one another, and thereby reduce this source of inductive heating.

In the example of FIG. 4A, superconducting cable 410 comprises cooling channel 418, which may for instance be a tubular cooling channel that runs along the longitudinal axis of the cable. Such channels may for instance provide a path for cryogenic liquid such as liquid helium or liquid nitrogen to flow and carry heat away from the conductive segments 412 and/or the HTS tape stacks 411. In some cases, one or more cooling channels may be arranged in contact with, or in close proximity to, the conductive segments 412. In such cases, cooling of the HTS tape stacks 411 may be achieved indirectly through cooling of the conductive segments. In other cases, one or more cooling channels may be arranged in contact with, or in close proximity to, the HTS tape stacks 411. Coolant may be provided through a cooling channel at a high pressure, such as above 2 bar.

In the example of FIG. 4A, cable 410 comprises a jacket 419 arranged exterior to the conductive segments 412. A jacket may provide additional structural stability over and above that provided by the conductive segments 412, and may for instance comprise, or may consist of, steel, Inconel®, Nitronic® 40, Nitronic® 50, Incoloy®, or combinations thereof. Further, as described above, the jacket may allow the core of the cable (e.g., everything except the solder 415 and jacket 419 in the example of FIG. 4A) to be enclosed so that solder can be directed through the cable during solder-filling.

The example of FIG. 4A depicts a cable 410 in which there are three conductive segments 412 with a stack of HTS tape arranged within each segment. It will be appreciated that in general a superconducting cable may be formed from any number of such conductive segments arranged around a central axis, and is not limited to being any particular number. For instance, in some cases there may be four, five or six conductive segments arranged around a central axis. The conductive segments may be substantially the same, thereby producing a structure with rotational symmetry as shown in FIG. 4A, though this is not a requirement. Although, using the same conductive segments may be advantageous in terms of ease of fabrication.

FIG. 4B is a cross-sectional view of an illustrative embodiment of superconducting cable 200 in which the core 202 is implemented as the core of cable 410, according to some embodiments. In the example of FIG. 4B, cable 420 includes the same components as cable 200 described above in relation to FIGS. 2A-2C, though the core 202 of the cable 200 is implemented using the core components of cable 410 described above. For instance, the conductive segments 412 are in the example of FIG. 4B arranged in a core that is inserted into the joint box 210. Conductive joint elements 206 are arranged over the portion of the core, which includes conductive segments 412 and stacks of HTS tape 411, within the joint box. It may be noted that the jacket 419 is not shown in the example of FIG. 4B because, as with the example of FIGS. 2A-2C, the jacket is not formed around the core within the joint box 210. However, the jacket 419 may be arranged around the remaining components of cable 410 at any or all of the parts of the cable 410 that are arranged outside of the joint box in superconducting cable 420.

In the example of FIG. 4B, solder (including regions of solder 415 and 208) is arranged around the stacks of HTS tape as in the example of FIG. 4A, and in addition is arranged above and below the core as in the example of FIGS. 2A-2C. It will be appreciated that during a solder-filling process these two regions of solder may be filled as a contiguous region of solder and that the two regions are only identified separately herein for ease of description. For example, during solder-filling, solder may be directed through the core of the superconducting cable 420, filling regions around the stacks of HTS to produce solder in regions 415 shown in FIG. 4A, and may further flow into the joint box 210, thereby filling regions 415 and filling solder region 208 around the stacks of HTS and above and below the core as shown in FIG. 4B. Thus, a single solder-filling process may produce a cable that exhibits both the cross-sectional view of FIG. 4A outside of the joint box and the cross-sectional view of FIG. 4B within the joint box.

To further illustrate the structure of a core such as those shown in FIGS. 4A and 4B, FIG. 4C depicts an isometric view of a superconducting cable having portions of an outer jacket 452 removed to reveal multiple conductive segments in a twisted configuration, according to some embodiments. In the example of FIG. 4C, the cable 430 is arranged to include four conductive segments, unlike the examples of FIGS. 4A and 4B which are arranged to include three conductive segments, although these four segments are not shown directly in FIG. 4C. Rather, only the superconductor components and insulating material are shown.

As described above, in some embodiments the multiple conductive segments may be twisted around a common axis along the length of the cable (e.g., a common central longitudinal axis of the cable). This configuration is shown in FIG. 4C, which depicts cable 430 comprising superconductor components 461 and insulating material 466. The intervening conductive segments that fill the space between the superconductor components 461 and the insulating material 466 are not shown for clarity. Arranging the superconductor components in a twisted shape may reduce the length over which two conductive paths are parallel to one another, and thereby reduce a source of inductive heating.

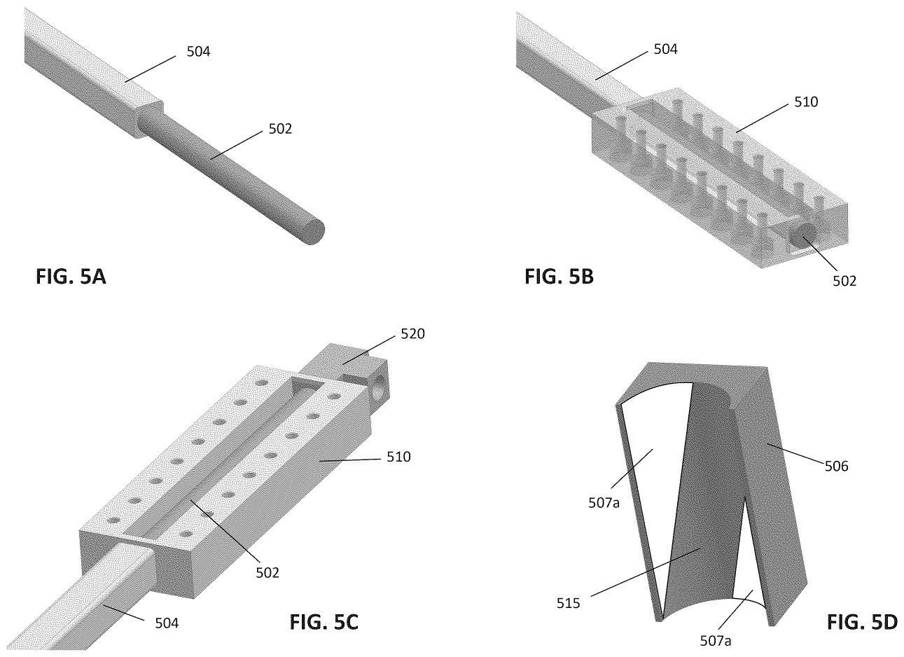

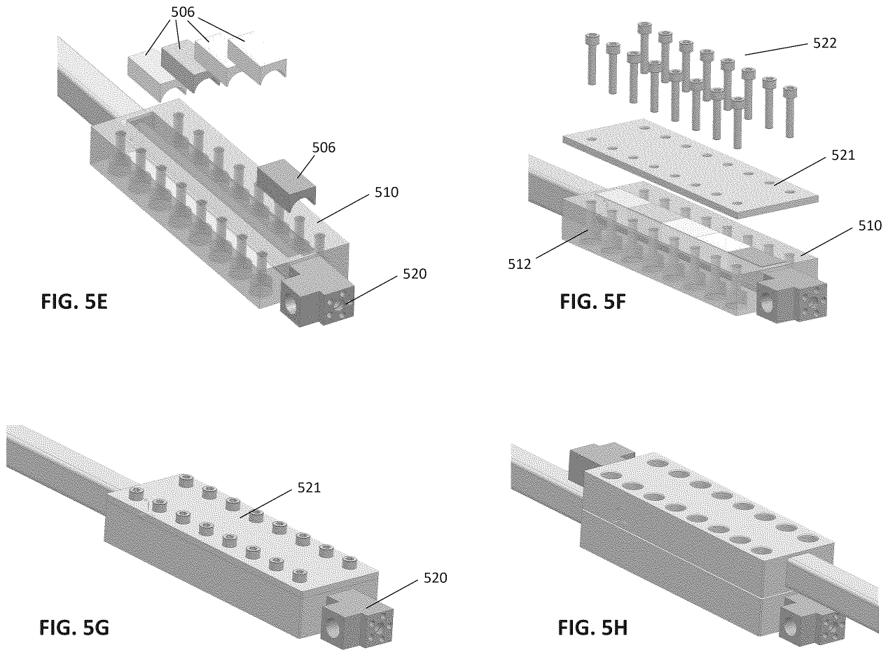

FIGS. 5A-5H depict steps in a process of forming an illustrative superconducting cable joint, according to some embodiments. The process depicted by FIGS. 5A-5H begins in FIG. 5A, with a core 502 and a jacket 504, with one end of the core exposed as shown. The core 502 may, for instance, be described by any of the cores described above, such as core 102 shown in FIG. 1, core 202 shown in FIG. 2, or the core configuration described above in relation to FIGS. 4A and 4C. Similarly, the jacket 504 may, for instance, be described by any of the jackets described above, such as jacket 104 shown in FIG. 1, jacket 204 shown in FIG. 2, or jacket 419 shown in FIG. 4A.

In FIG. 5B, the end of the core 502 is inserted into a joint box 510. As shown, the core may be inserted such that the jacket extends up to, or close to, one end of the joint box, and the end of the core is arranged at or close to the other end of the joint box. As such, in some cases the exposed length of the core prior to insertion into the joint box may be arranged to have a length that is equal or approximately equal to the length of the joint box. At this stage, the core may be loosely held in the joint box, although it may in some embodiments be held to some degree through pressure fitting (e.g., if the core is close to, but slightly smaller than, a portion of the joint box such that the core is held in place once inserted) and/or by coupling the joint box to the core via one or more suitable fasteners (not shown in FIG. 5B). In some embodiments, the jacket 504 may be attached to one end of the joint box to ensure there is no open space between the jacket and the joint box. For instance, the jacket may be welded to the joint box.

In FIG. 5C, an end cap 520 is attached to an end of the joint box opposite to the end in which the core was inserted. In particular, the end cap 520 may be arranged over an outlet in the joint box to extend the open channel represented by the open space in the core. It may in some cases be desirable for a solder-filling process to have a suitable fitting on the joint box to which to couple systems used in such a process. While in some cases the joint box may be formed to comprise such a structure, in the example of FIGS. 5A-5H, the end cap 520 is attached (c.g., welded) to the joint box to perform such a function, Thus, during solder-filling, the solder can flow through the open space in the core, through the joint box, and then through the end cap.

FIG. 5D depicts a single conductive joint element 506 to be inserted into the joint box 510. The concave portion of the lower surface of the conductive joint element 506 includes regions where insulating material 507a has been applied to the surface of the conductive joint element. This insulating material may be applied in locations to match the trajectory of the superconducting material in the core so that the exposed conductive surfaces of the conductive joint elements are arranged next to the superconducting material in the core.

In the example of FIG. 5D, the exposed conductive surface 515 has a curved shape that follows a helical path. As described above, in some cases a core may be twisted so that regions of superconducting material in the core follow a helical path. By placing the insulating material 507a (e.g., polyimide) on the concave region of the lower surface of the conductive joint element 506, the conductive joint element may be arranged over a portion of the superconducting material's helical path and the conductive joint element positioned so the exposed conductive surface 515 is directly over this portion of the helical path. Such an arrangement may lower the resistance of current flow from the superconducting material through the conductive joint element by providing a more direct path to and through the conductive joint element.

In FIG. 5E, a plurality of conductive joint elements 506 are arranged within the opening in the top of the joint box. In some embodiments, the conductive joint elements may be positioned laterally such that exposed conductive surfaces of each conductive joint element are aligned with superconducting material in the core 502. It will be appreciated that the locations of the insulating material 507a may not be the same for each conductive joint element, depending on the path that superconducting material takes within the core 502. However, in some cases the conductive joint elements 506 may be formed to be the same, with the same locations of insulating material 507a, and with a length selected such that periodic paths of the superconducting material in the core align with each of the exposed conductive surfaces of the conductive joint elements.

In FIG. 5F, a lid 521 is coupled to the top of the joint box 510 via fasteners 522 (bolts in the example of FIG. 5F) to enclose the joint box in preparation for a solder-filling process. The fasteners 522 pass through holes 512 in the joint box 510 and allow for the lid 521 to be firmly attached to the joint box. While it is desirable that the conductive joint elements 506 are substantially flat prior to attaching the lid 521 so that the lid can full enclose the joint box, it is not necessary that the conductive joint elements 506 be fully planar at this point, as it may be desirable to modify them to be planar after solder-filling is complete.

FIG. 5G shows the joint box 510 with the lid 521 fully attached. A solder-filling process may then be performed in which molten solder flows through the core of the cable, filling space in the core and the joint box, and passing out through the end cap 520. Subsequently, the lid 521 may be removed and material removed from the conductive joint elements 506 so that they are planar (e.g., they may be machined flat). In some embodiments, the superconducting cable is bent into a desired shape (e.g., a spiral shape for a magnet) prior to the solder-filling process being performed, which may cause the shape of the cable to be fixed.

Multiple superconducting cables may be formed through the process illustrated by FIGS. 5A-5G, then electrically connected via the joint boxes of each cable. In some embodiments, a joint box may be attached to both ends of a single cable via the techniques described herein. In this case, during a solder-filling process, the molten solder would flow through a first end cap, through a first joint box, through the core of the cable, through a second joint box, then through a second end cap.

In FIG. 5H, two superconducting cables are electrically connected by placing the conductive joint elements of each cable face-to-face as shown. In some embodiments, a layer of a soft metal, such as indium, may be placed between the conductive joint elements to ensure a reliable electric connection between the two cables. The two joint boxes may then be coupled to one another by passing fasteners (not shown) through the holes of each joint box, which are aligned so that a single fastener (e.g., bolt) can pass through the through holes in both joint boxes. Tightening these bolts thereby provides a strong mechanical and electrical coupling between the two cables.

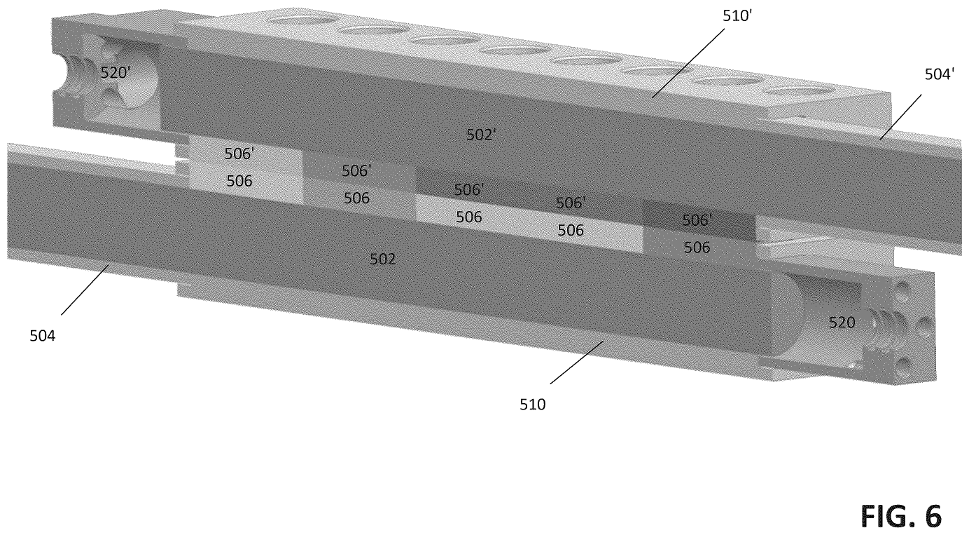

A cross-sectional view of the joint between two superconducting cables produced by the process depicted in FIGS. 5A-5H is shown in FIG. 6. In the example of FIG. 6, the conductive joint elements 506 and 506′ are shaded with different shades of grey. Each superconducting cable is labeled with the same numeral as in FIGS. 5A-5H, with the second, upper cable being labeled with the same numeral with a prime (′) symbol (e.g., jacket 504 in the lower cable is labeled as jacket 504′ in the other cable, etc.).

As shown in FIG. 6, the conductive joint elements 506 and 506′ may be aligned once the joint is formed. If insulating material is arranged between the conductive joint elements in each cable, each conductive joint element thereby acts as a separate electrical contact for the cable. In cases where each conductive joint element is electrically connected to one region of superconducting material in the core, this configuration may allow current to flow through the superconducting material in one cable, through a pair of conductive joint elements, and into superconducting material in the other cable with there being multiple such distinct and separate current paths through the two cables.

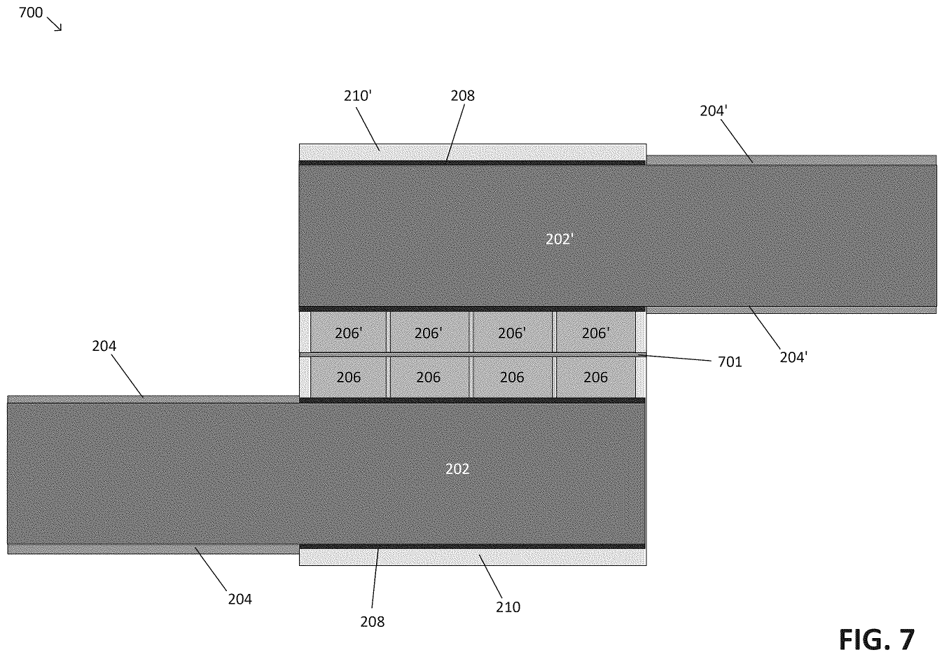

FIG. 7 depicts two instances of cable 200 shown in FIGS. 2A-2C coupled together to form a joint, according to some embodiments. In the example of FIG. 7, the joint 700 is formed from two cables arranged with the conductive joint elements 206 and 206′ arranged face-to-face with a layer of a metal 701, such as indium, placed between the two sets of conductive joint elements. In the example of FIG. 7, one instance of the cable is labeled with a prime (′) symbol after the relevant numeral (e.g., jacket 204 in the lower cable is labeled as jacket 204′ in the other cable, etc.).

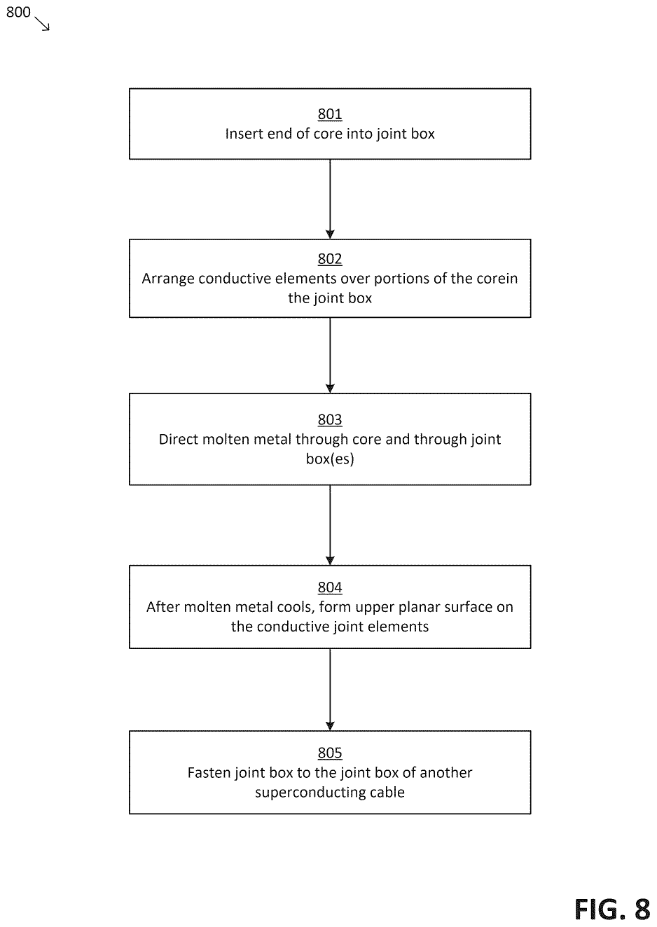

FIG. 8 is a flowchart of a method of forming a joint between superconducting cables, according to some embodiments. Method 800 may for instance be performed to fabricate one or more superconducting cables such as those described herein, including cable 100, cable 200 or cable 420, and to join two of the cables together to form a conductive joint between the cables.

In act 801, a first end of a core is inserted into a joint box. In some cases, a jacket may be added to those portions of the core outside of the joint box after insertion of the core, and in other cases, a jacket may be already arranged around part of the core before insertion. Act 801 may comprise attaching a jacket around the core to an exterior of the joint box (e.g., via welding).

In act 802, one or more conductive joint elements are arranged over at least some of the portions of the core that were inserted into the joint box in act 801. The one or more conductive joint elements may be inserted into an opening in the top of the joint box and may rest on top of, or otherwise be arranged over, the at least some of the portions of the core that were inserted into the joint box in act 801. As described above, in some cases, the one or more conductive joint elements may include at least one conductive joint element with a concave portion in its lower surface, and/or at least one conductive joint element with insulating material (e.g., polyimide) arranged on a portion of the lower surface. In some embodiments, the one or more conductive joint elements are arranged in act 802 with insulating material (e.g., polyimide) between neighboring conductive joint elements. In some cases, the insulating material may be affixed to a side of the conductive joint elements prior to arranging the conductive joint elements in the joint box.

According to some embodiments, acts 801 and 802 may be performed for one or both ends of a core. As such, two ends of a core may be inserted into respective joint boxes in the manner described with respect to acts 801 and 802.

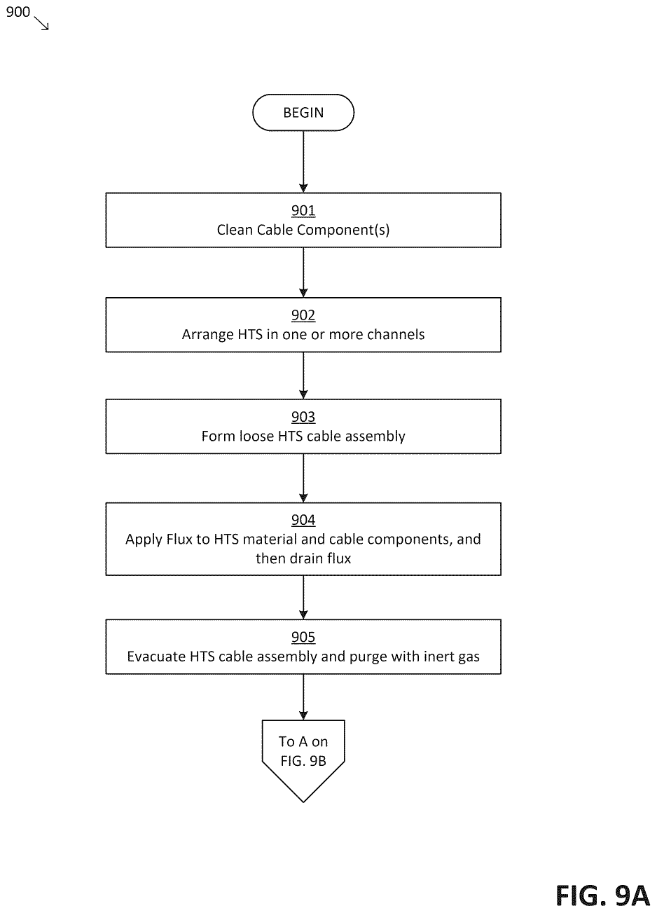

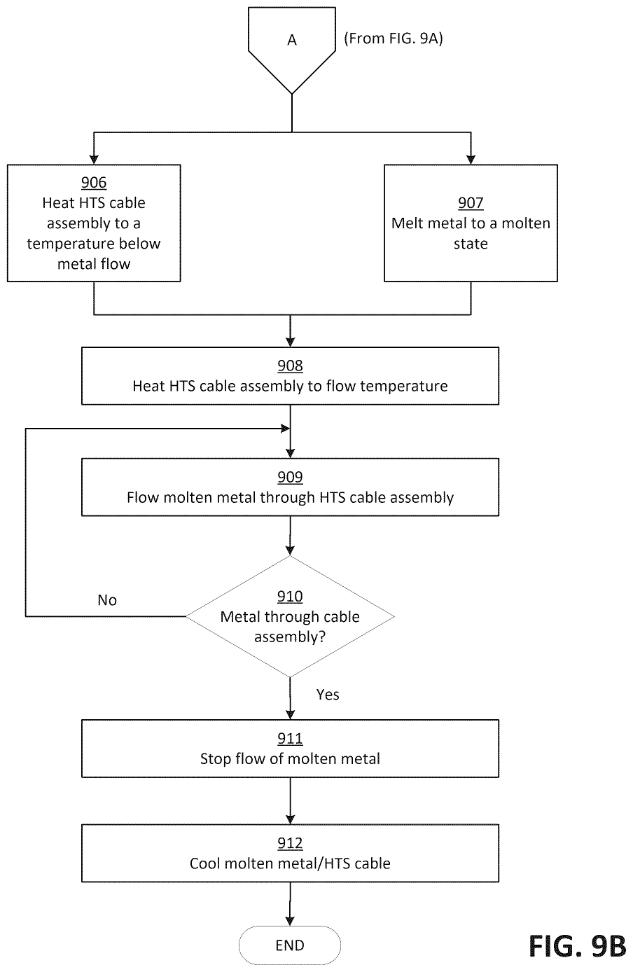

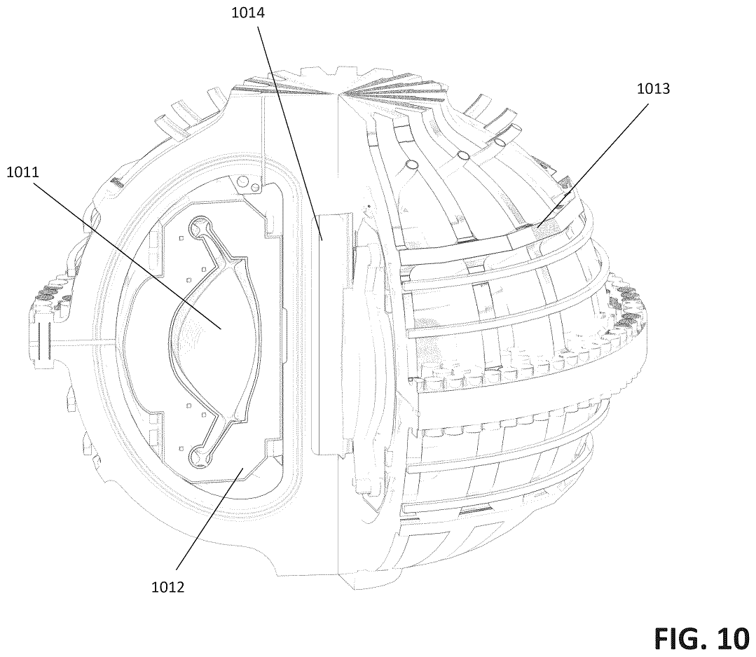

In act 803, a molten metal is directed through the superconducting cable and through one or more joint boxes. An illustrative example of such a process is described below in relation to FIGS. 9A and 9B. In some cases, act 803 may comprise directing the molten metal through a cable having a joint box at each end, such that the molten metal flows into a first joint box (optionally through an end cap affixed to the first joint box), through the core of the cable, and through a second joint box (and optionally out through an end cap affixed to the second joint box). In some cases, act 803 may comprise directing the molten metal through a cable having a joint box at only one end, such that the molten metal flows into a joint box (optionally through an end cap affixed to the joint box), through the core of the cable, and out the other end of the core of the cable; or may comprise directing the molten metal to flow through the core of the cable and out through the joint box (optionally through an end cap affixed to the joint box).

Subsequent to the solder-filling process performed in act 803, material may be removed from one or more conductive joint elements in a joint box (or in each of two joint boxes) to produce a planar surface. In some embodiments, subsequent to removal of material, the planar surface collectively exhibited by the one or more conductive joint elements in a joint box may be flush with an upper surface of the joint box. Removal of material from conductive joint elements in act 803 may comprise, but are not limited to, milling, grinding, sanding, machining, polishing or combinations thereof.

As referred to herein, the one or more conductive joint elements having a “planar” upper surface means that the one or more conductive joint elements have a sufficiently flat upper surface that the conductive joint elements can be arranged flush with another such surface. Since the purpose of the planar surface is to place two joint boxes in contact (or in contact with an intervening soft metal), a planar surface need not be perfectly flat, but should be sufficiently flat that a reliable electric connection can be formed between two such planar surfaces.

Act 801-804 may be performed one or more additional times to produce a plurality of superconducting cables each comprising one or more joint boxes. In act 805, a pair of such cables may be coupled together to form a joint between the two superconducting cables by coupling two joint boxes of the cable to one another. According to some embodiments, two joint boxes may be coupled together via one or more fasteners, clamps, clasps, mating components, latches, or combinations thereof.

FIGS. 9A-9B are a flow diagram of a method of metal-filling a superconducting cable, according to some embodiments. The method 900 may be performed with any suitable superconducting cable, including any of the cables described herein. It should be appreciated that, unless explicitly stated, the processing actions in the flow diagram are unordered meaning that the processing actions listed in the flow diagram may be performed in any convenient order.

Referring now to FIGS. 9A-9B, an illustrative process for filling an HTS cable (e.g., any of the cables described herein) with a metal (e.g., solder) begins in act 901 by cleaning one or more components of a cable (e.g., any components described above, such as one or more channels of an electrically conductive structure, one or more channels of one or more conductive segments, a channel within a former, HTS materials, jacket, fittings, or combinations thereof) that will undergo a metal-filling process. In some embodiments, act 901 comprises cleaning the one or more cable components by flushing the component(s) with an acidic solution and then rinsing the component(s) with water and/or another liquid. Details of an illustrative example of such a process are described below.

Herein, the material for filling is generally referred to as a “metal” for convenience, although the material need not be a pure metal, and could for instance be a metal alloy. As such, in the below description, references to a “metal” used in the process should be understood to also encompass metal alloys.

As one non-limiting example of cleaning one or more components of a cable, a reservoir comprising a mixture of water and a cleaning solution (e.g., Citronox acidic cleaner) is coupled to a cable former and the water/cleaning solution mixture is pumped or otherwise delivered from the reservoir through the cable former. Subsequently, a rising fluid (e.g., clean water) is pumped through the cable former to rinse the water/cleaning solution mixture out of the cable former. In some cases, the water/cleaning solution mixture and/or the rinsing liquid may be heated to above room temperature (e.g., to 140° F.).

Subsequently to cleaning the component(s) in act 901, HTS material is arranged in one or more channels of an electrically conductive structure, and/or in one or more channels of one or more conductive segments in act 902, thereby producing an arrangement of HTS as described above (e.g., the arrangement of an HTS tape stack 411 within an conductive segment 412 as shown in FIG. 4A). In some embodiments, the HTS material arranged in one or more channels in act 902 may comprise one or more stacks of HTS tape. In some embodiments, the HTS tape stack may be pre-tinned to assure a good bond between tapes (e.g., a bond in which tapes are securely coupled together). In some embodiments, the HTS tape stack may be pre-tinned with the metal to be used to fill the cable. In some embodiments, an HTS tape is pre-plated with lead-tin (PbSn) solder (or a lead-tin solder alloy).

In act 903, a so-called “loose HTS cable assembly” (or more simply an “HTS cable assembly”) is formed. The HTS cable assembly is sometimes referred to as a “loose cable assembly” since at least the HTS material (and possibly other components) have not been structurally secured to the channels or other structure which forms part of the HTS cable. The HTS cable assembly may be produced directly as a result of arranging the HTS within one or more channels in act 902, or may be produced as a result of additional steps subsequent to act 902.

As used herein, an “HTS cable assembly” or “loose HTS cable assembly” may refer to a cable structure that comprises an HTS material (e.g., an HTS tape), examples of which are provided herein. For instance, one type of HTS cable assembly comprises HTS material disposed within a channel of a former, with optional additional fittings, etc. In some embodiments, an HTS cable assembly may comprise HTS tape disposed on the bottom of a channel. Although in the above illustrative embodiments the cable former is shown having a circular cross-sectional shape, in other embodiments the former may be provided having a different cross-sectional shape (e.g., an oval cross-sectional shape, a rectangular cross-sectional shape, a square cross-sectional shape or any regular or irregular geometric cross-sectional shape).

At any point before or after HTS material is disposed in the HTS cable assembly (e.g., after HTS material is disposed in a channel of a former or other structure), the HTS cable assembly may be bent into a desired shape (e.g., a coil, a circular shape, a loop or a multi-loop shape).

Returning to FIG. 9A, in act 904 flux is optionally applied to some or all of the HTS material and/or cable components that will form the HTS cable, to remove any oxidation on the surface of the HTS material and/or cable components. In some embodiments, a liquid flux may be applied shortly prior to soldering. Ideally, the flux penetrates all surfaces of the cable components that will be exposed to molten metal, in a manner similar to the subsequent flow of molten metal to be described below. In some embodiments, it has been found that application of liquid flux enables good wetting of solder to tape and cable. In some embodiments, act 904 may comprise applying RMA-5 liquid flux (Indium Corp) and/or Select-10 Flux (Kester) which has lower resin content and corrosivity. It should be appreciated, however, that other liquid fluxes having the same or similar characteristics to RMA-5 liquid flux may also be applied in act 904.

In act 905, the HTS cable assembly is then evacuated (e.g., by arranging the HTS cable assembly in a chamber and evacuating the chamber) and the HTS cable assembly purged with a gas, such as an inert gas. In embodiments in which flux was applied in act 904, any excess flux (e.g., flux which does not adhere to the HTS material or components) may be drained from the assembly as a result of the evacuation in act 905. It has been found however, that any remaining flux may effectively be flushed by the flow of heavier molten metal solder (to be described in conjunction with act 909). As such, an explicit step of draining excess flux may not be required, depending upon how much flux remains in the assembly. In embodiments having long and complex cable geometries, pressurization may be used to drain excess flux. Following fluxing, if used, the cable assembly is again evacuated and purged with an inert gas to remove oxygen which, if present, would interfere with the effective action of the flux when it is heated.

In act 906, the HTS cable assembly is heated to a first temperature. In the case of a pure metal being used for the metal filling process of FIGS. 9A-9B, the first temperature may be selected to be below the melt temperature of the metal. In the case of a metal alloy being used for the metal filling process of FIGS. 9A-9B, the first temperature may be selected to be below the liquidus temperature of the metal alloy.

In some embodiments, act 906 may comprise heating the HTS cable assembly and any associated fittings and piping within an oven, such as a convection oven. This type of heating may provide a degree of uniformity with reduced (and ideally minimal) external temperature control needed and, importantly, reduces (and ideally avoids), the risk of HTS tape temperature exceeding the oven setpoint and causing degradation to that portion of the HTS tape (and hence that portion of the cable) due to exposure to undesirable temperatures.

Either before, after or concurrently with the heating of the cable assembly in act 906, the metal with which the HTS cable assembly will be filled is melted to a liquid state (or a solid/liquid state in the case of an alloy) in act 907. The metal may be melted, for example, using temperature-controlled heaters in a container (also sometimes referred to herein as a can or crucible). Thermocouples inside and/or outside the can may be used to determine when the melting process is complete, and the temperature of the molten metal before flowing. In some embodiments, the metal may be melted inside the oven in which the cable is located but in other embodiments, the metal may be melted separately (e.g., outside the oven). The HTS cable assembly is then heated to a temperature at which the metal will flow in act 908.

One aspect of the metal fill process found to be significant has been obtaining a desirable time-temperature profile. Temperatures need to be high enough for the metal to be fluid with low viscosity, yet result in low enough exposure to avoid thermal degradation, and degradation due to chemical effects of the metal on the HTS material (e.g., a rare earth barium copper oxide (REBCO) tape stack).

In some embodiments for solder filling of an HTS cable comprising an HTS tape stack comprising layers of REBCO tape and using a tin-lead (PbSn) solder, two steps may be performed. First, the oven is set to a temperature that warms the HTS cable assembly, but which does not degrade (or substantially degrade) the HTS tape. In some embodiments, the oven may be set to a temperature below the melt point of the solder disposed on the HTS tapes (e.g., the oven may be set to heat to 185° C. when the process is to fill the cable with a PbSn solder) to thereby greatly reduce, and ideally to avoid, degradation of the HTS tape stack. The heating process is continued until the temperature of the entire cable (or more properly the cable assembly) has reached the set temperature of the oven.

The oven set temperature is held at this temperature until a solder supply (e.g., a supply of solder in the can) is fully melted and equilibrated to the process temperature of about 200° C. Second, the oven temperature may then be set to a temperature which achieves a desired flow temperature of the solder. In embodiments utilizing PbSn solder, the oven temperature may be set to a temperature of about 205° C. and a waiting period occurs until all points on the cable and any associated tubing required for the metal-fill process have achieved a desired flow temperature (e.g., a flow temperature of about 200° C. in the case of PbSn solder) and temperature monitoring is performed to ensure that no point of the HTS cable assembly exceeds a temperature of about 200° C. In some embodiments, a dwell period may be performed at an intermediate temperature, such at around 194° C. This approach reduces, and ideally avoids, degradation of the superconducting properties of the HTS tape stack. Once these temperature conditions are met, the metal flow process begins in act 909, and preferably promptly begins so as to reduce, and ideally minimize, the amount of time the HTS tape stack is exposed to such relatively high temperatures (e.g., temperatures above or about 200° C.).

Application and monitoring of a plurality of temperature monitoring devices (e.g., thermocouples) at multiple points in a metal-fill processing station and on the cables may be important to the process, since degradation of some HTS materials (e.g., REBCO) increases exponentially with temperature above 200° C. The locations of the temperature monitoring devices are selected for each cable geometry. Considerations will include the size and expected thermal uniformity of the cable, and the local measurements which will be needed to guide the planned cooling process. Temperatures may be adjusted for different solders or different types of HTS materials. Such an optimized time-temperature profiles for solder-filling (or more generally, metal-filling) of HTS cables is unique to the process described herein and is one factor leading to the success of the described technique, even when solders such as Sn₆₀Pb₄₀ are used whose melt temperature is high enough to potentially damage HTS.

Alternate solder alloys may also be used which reduce degradation. The choice of suitable solders for a given application will depend on the required properties-including but not limited to mechanical, thermal and electrical, for the application of the cable.

Acts 909 and 910 may be performed as a loop to ensure that molten metal flows through the entire cable assembly in act 909. In some embodiments, the flow of molten metal through the entire cable assembly may be achieved at least partially via gravity (i.e. at atmospheric pressure), via a displacement pump, or using a vacuum-pressure technique.

In act 910, once a decision has been made that sufficient molten metal has flowed through the portion (or portions) of the cable assembly in which the HTS material is disposed, then the flow of molten metal is stopped in act 911 and the molten metal and HTS cable assembly are cooled (act 912) and after cooling is complete a solder-filled (or more generally, metal-filled) HTS cable is resultant. It should be noted that in some embodiments, the flow of molten metal (e.g., solder in a liquid state) does not stop as soon as the metal is through the cable. Rather, metal flow is not stopped until a predetermined quantity of metal is through the cable and has reached a dump. Flowing additional metal beyond simply filling the cable may be beneficial in removing flux from the cable and/or in reducing the void fraction in the metal-filled cable once the metal returns to a solid state.

In some embodiments, cooling in act 912 may comprise simply waiting until the HTS cable assembly has reached room temperature, without any active cooling. In some embodiments, cooling in act 912 may comprise active cooling including the use of fans or cold elements, etc.

In the illustrative method shown in FIGS. 9A and 9B, it will be appreciated that an HTS cable may be formed without performing all processing acts shown in FIGS. 9A-9B and/or in the specific order presented. As one non-limiting example, depending on cleanliness of the received former, cleaning in act 901 may not be necessary in all instances, Furthermore, in at least some cases some portions of the method might be performed simultaneously. As one non-limiting example, in some cases the application of flux in act 904 may be performed after evacuation of the HTS cable assembly in act 905. As another non-limiting example, in some cases heating the HTS cable assembly in act 906 and melting of the metal in act 907 may be performed concurrently, or either step may be started or even completed prior to the other beginning. In some cases, act of the illustrative method (and/or portions of the acts) shown in FIGS. 9A and 9B may be omitted entirely, For instance, in some embodiments, act 904 in which flux is applied to the HTS material and drained may be omitted. In some embodiments, the purging aspect of act 905 may be omitted while the evacuation aspect of act 904 is performed.

In addition to the process shown in FIGS. 9A-9B and described above, any of the techniques shown or described in PCT Application No. PCT/US2020/060170, filed on Nov. 12, 2020, titled “Processes, Systems and Devices for Metal Filling of High Temperature Superconductor Cables,” which is hereby incorporated by reference in its entirety, may also be employed to produce a superconducting cable as described herein.

FIG. 10 is a three-dimensional graphic of a fusion power plant with a cutaway portion illustrating various components of the power plant, according to some embodiments. A magnet within a fusion power plant may be formed from a superconductor arrangement as described above. FIG. 10 shows a cross-section through a power plant and includes a magnet coils 1013 and 1014, either or both of which is fabricated from, or otherwise includes, a superconducting magnet comprising a plurality of HTS cables as discussed and described above, a neutron shield 1012, and a core region 1011. According to some embodiments, the magnet coil 1013 may be, or may form part of, a poloidal field coil. According to some embodiments, the magnet coil 1014 may be, or may form part of, a central solenoid.

Persons having ordinary skill in the art may appreciate other embodiments of the concepts, results, and techniques disclosed herein. It is appreciated that superconducting magnets configured according to the concepts and techniques descried herein may be useful for a wide variety of applications. For instance, one such application is conducting nuclear magnetic resonance (NMR) research into, for example, solid state physics, physiology, or proteins. Another application is performing clinical magnetic resonance imaging (MRI) for medical scanning of an organism or a portion thereof, for which compact, high-field magnets are needed. Yet another application is high-field MRI, for which large bore solenoids are required. Still another application is for performing magnetic research in physics, chemistry, and materials science. Further applications are in magnets for particle accelerators for materials processing or interrogation; wind power generators and other electrical power generators; medical accelerators for proton therapy, radiation therapy, and radiation generation generally; superconducting energy storage; magnetohydrodynamic (MHD) electrical generators; and material separation, such as mining, semiconductor fabrication, and recycling. It is appreciated that the above list of applications is not exhaustive, and there are further applications to which the concepts, processes, and techniques disclosed herein may be put without deviating from their scope.

As referred to herein, the phrases “HTS material,” “HTS superconductor material” or “HTS superconductor” refer to a superconducting material having a critical temperature above 30°K at zero self-field. One example of an HTS material is rare-earth barium copper oxide (REBCO). An “HTS magnet” is a magnet that includes one or more HTS materials arranged to carry at least a portion of the current of the magnet. A cable comprising HTS material is referred to herein as an “HTS cable.”

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

The above-described embodiments of the technology described herein can be implemented in any of numerous ways. Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within +5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A superconducting cable comprising:
a core comprising a plurality of high temperature superconductor (HTS) components;
a joint box arranged at an end of the superconducting cable, with a portion of the core arranged inside the joint box;
a plurality of conductive joint elements arranged at least partially within the joint box and arranged side-by-side over the portion of the core arranged inside the joint box;
one or more insulating layers arranged between adjacent ones of the plurality of conductive joint elements; and
solder arranged within the core and within the joint box.

2. The superconducting cable of claim 1, further comprising a jacket surrounding portions of the core outside of the joint box.

3. The superconducting cable of claim 2, wherein an end of the jacket is attached to the joint box.

4. The superconducting cable of claim 1, wherein the solder contacts the plurality of HTS components and the plurality of conductive joint elements.

5. The superconducting cable of claim 1, wherein the core comprises a plurality of conductive segments extending along the cable, each of the plurality of conductive segments comprising one or more of the plurality of HTS components.

6. The superconducting cable of claim 5, further comprising an insulating material arranged between adjacent conductive segments of the plurality of conductive segments in the core, which electrically insulate the plurality of conductive segments from one another.

7. The superconducting cable of claim 5, wherein the core further comprises at least one interior cooling channel.

8. The superconducting cable of claim 5, wherein the plurality of HTS components comprise a plurality of HTS tapes, and wherein a stack of HTS tapes is arranged within each conductive segment of the plurality of conductive segments.

9. The superconducting cable of claim 5, wherein the plurality of conductive segments are twisted around a central axis of the superconducting cable, and wherein the one or more HTS components in each conductive segment follow a helical path around the central axis.

10. The superconducting cable of claim 5, wherein the joint box further comprises an outlet, and wherein the solder is arranged up to or beyond the outlet.

11. The superconducting cable of claim 9,
wherein a first conductive joint element of the plurality of conductive joint elements is arranged adjacent to one or more HTS components arranged within a first conductive segment of the plurality of conductive segments of the core, and
wherein a second conductive joint element of the plurality of conductive joint elements is arranged adjacent to one or more HTS components arranged within a second conductive segment of the plurality of conductive segments of the core.

12. The superconducting cable of claim 11, further comprising insulating material on a portion of a lower surface of the first conductive joint element such that a remaining portion of the lower surface is adjacent to and follows a shape of the helical path of the one or more HTS components arranged within the first conductive segment.

13. (canceled)

14. The superconducting cable of claim 1, wherein the plurality of conductive joint elements collectively exhibit a planar upper surface.

15. The superconducting cable of claim 1, wherein the plurality of conductive joint elements each has a concave portion in its lower surface.

16. A superconducting magnet comprising:
a first superconducting cable comprising:
a first core comprising a first plurality of high temperature superconductor (HTS) components;
a first joint box arranged at an end of the first superconducting cable, with a portion of the first core arranged inside the first joint box;
a first plurality of conductive joint elements arranged at least partially within the first joint box and arranged side-by-side over the portion of the first core arranged inside the first joint box, wherein the first plurality of conductive joint elements collectively exhibit a first planar surface;
a second superconducting cable comprising:
a second core comprising a second plurality of high temperature superconductor (HTS) components;
a second joint box arranged at an end of the second superconducting cable, with a portion of the second core arranged inside the second joint box;
a second plurality of conductive joint elements arranged at least partially within the second joint box and arranged side-by-side over the portion of the second core arranged inside the second joint box, wherein the second plurality of conductive joint elements collectively exhibit a second planar surface; and
solder arranged within: the first core, the second core, the first joint box and the second joint box,
wherein the first planar surface and the second planar surface are arranged face-to-face with one another and electrically connected to one another.

17. The superconducting magnet of claim 16, further comprising a first jacket surrounding portions of the first core outside of the first joint box, and a second jacket surrounding portions of the second core outside of the second joint box.

18. The superconducting magnet of claim 17, wherein an end of the first jacket is attached to the first joint box, and wherein an end of the second jacket is attached to the second joint box.

19. The superconducting magnet of claim 16, further comprising a layer of indium arranged between the first planar surface and the second planar surface.

20-29. (canceled)

30. A method of forming a joint between superconducting cables, the method comprising:
inserting an end of a superconducting cable core comprising a plurality of high temperature superconductor (HTS) components into a joint box;
arranging one or more conductive joint elements over portions of the superconducting cable core within the joint box;
directing a molten metal through the superconducting cable core and through the joint box, thereby electrically connecting at least some of the plurality of HTS components to at least some of the one or more conductive joint elements via the molten metal; and
subsequent to cooling of the molten metal, removing material from an exposed upper surface of the one or more conductive joint elements to form a planar surface.

31. The method of claim 30, wherein the method further comprises providing a jacket around the superconducting cable core after inserting the end of the superconducting cable core into the joint box and prior to directing the molten metal through the superconducting cable core and through the joint box, wherein the jacket is arranged around portions of the superconducting cable core outside of the joint box.

32-46. (canceled)
